(19) United States
(12) Patent Application Publication
(10) Pub. No.: US 2010/0119652 A1
(43) Pub. Date: May 13, 2010

(54) Formula and process for producing gluten-free bakery products

(76) Inventors: Trupti Palav, Tonawanda, NY (US); Sachin Bhatia, Tonawanda, NY (US); Cheryl Perks, Ridgeway (CA)

Correspondence Address: HODGSON RUSS LLP;THE GUARANTY BUILDING, 140 PEARL STREET, SUITE 100, BUFFALO, NY, 14202-4040, US

(21) Appl. No.: 12/590,521

(22) Filed: Nov. 10, 2009

Related U.S. Application Data
(60) Provisional application No. 61/113,003, filed on Nov. 10, 2008.

(51) Int. Cl. A21D 13/08

(52) U.S. Cl. 426/62

(57) ABSTRACT

Gluten-free formulations for the production of gluten-free bakery products. The formulations comprise gluten-free starch or starches which mimic the starch particle size found in wheat. The formulations can used to prepare bakery products such as breads and cakes.

### CROSS-REFERENCE TO RELATED APPLICATIONS

This application claims priority to U.S. Provisional Patent Application No. 61/113,003, filed on Nov. 10, 2008, the disclosure of which is incorporated herein by reference.

### FIELD OF THE INVENTION

The present invention relates generally to gluten-free food products and more particularly provides a formulation and method for producing gluten-free batter for bread as well as cake mixes.

### BACKGROUND OF THE INVENTION

The gluten present in wheat provides a protein structure useful for processing of baked wheat goods and also provides desirable organoleptic properties. However, in individuals afflicted with celiac disease, consumption of gluten containing food products is not recommended as gluten is considered to generate undesirable and harmful immune response. Thus, there has been a recent push to develop food items which are gluten free.

Currently the gluten-free breads and rolls available in the market have several drawbacks. For example, these products are generally pasty and have a gritty mouth-feel, crumbly texture, poor shelf life after baking under ambient conditions, and poor taste as compared to white bread.

U.S. Patent Application Nos. 2008/0038434 (WO 2008/022092); 2009/0092716; 2009/0098270 provide gluten-free batter systems which requires the use of polymers to replace the gluten. The polymer system has a gas retaining agent and a setting agent. In the absence of the polymer system, the product is stated to lack a chewy texture and fell apart easily in the mouth. Further, the addition of polymers may impart a non-natural attribute to the formulation. Thus, there continues to be a need for gluten-free formulations which contain natural ingredients and yet have a desirable texture and mouthfeel.

### BRIEF SUMMARY OF THE INVENTION

The present invention describes compositions for gluten-free bread and cake formulations. In one embodiment, a formulation for bread bakery products comprises gluten-free starch and/or flour, protein, hydrocolloid, yeast, emulsifier, water, and optionally, chemical leavening agents, sweetener, fat, flavors or inclusions, or acidulant. In another embodiment, a formulation for cake bakery products comprises gluten-free starch and/or flour, protein, hydrocolloid, emulsifier, water, fat, chemical leavening agent and optionally, sweetener, flavors or inclusions, or acidulant.

In one embodiment, the formulation does not contain dairy ingredients and/or soy and/or wheat ingredients.

In one embodiment, the formulation comprises other ingredients (such as dough conditioners, shelf-like extenders, enzymes and anti-staling agents).

The formulations can be used for breads, cakes, muffins and biscuits. In the bread formulation embodiment, the batter formulation and baked products resulted in a structure similar to regular wheat-based yeast-leavened baked products. The baked product made with compositions of the present invention does not have off flavor and has a clean flavor similar to that of regular wheat based yeast leavened baked products. The texture and baked specific volume is similar to that of white bread.

The invention uses a starch blend that mimics the characteristics of wheat starch granules. Wheat starch has A & B type granules that gelatinize over a broad range of temperature. This invention uses a starch blend which mimics wheat starch in this aspect.

Corn starch is a necessary component of the formulation. Dent corn (also known as “field corn”) is a variety of corn which is higher in starch and lower in sugar than table corn, the type of corn eaten as a vegetable. In one embodiment, only corn starch is used in the formulation. In another embodiment, corn starch is combined with additional starch or starches (such as tapioca, modified tapioca starch, potato starch and rice flour).

In one embodiment, the formulation does not contain dairy protein. In another embodiment, the formulation contains dairy protein.

In one embodiment, the compositions are used to prepare bread and similar baked products. In another embodiment, a bread formulation comprises xanthan gum, guar gum, pectin, and methyl cellulose.

In another embodiment, the compositions of the present invention are used to prepare cake and similar baked products.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. Graphical representation of a wheat starch DSC thermogram.

FIG. 2. Graphical representation of a present invention (Formula 3) DSC thermogram.

FIG. 3. Pictorial representation of a gluten-free bread prepared from comparative example formulation using present process.

FIG. 4. Pictorial representation of a gluten-free bread prepared from present formulation using present process.

FIG. 5. Pictorial representation of a gluten-free sandwich roll bread prepared from present formulation using present process (left); comparative formulation using comparative process (right).

FIG. 6. Pictorial representation of a gluten-free sandwich roll bread prepared from present formulation baked using comparative process.

FIG. 7. Pictorial representation of a gluten-free bread prepared from present formulation using present process (top left); present invention using comparative process (bottom left); comparative formulation using present process (top right); comparative formulation using comparative process (bottom right).

FIG. 8. Pictorial representation of a gluten-free bread. Close-up view of bread prepared from present formulation using present process.

FIG. 9. Pictorial representation of a gluten-free bread. Close-up view of bread prepared from present formulation using comparative process.

FIG. 10. Pictorial representation of gluten-free cake (a) top and (b) bottom prepared from present formulation, present process.

FIG. 11. Particle size data comparison of wheat starch and corn/tapioca starch blend.

FIG. 12. Particle size data comparison of various flours/starches.

FIG. 13. Example of viscosity data at various stages of measurement.

FIG. 14. Table summarizing viscosity data at various stages of measurement for various flour/starches.

FIG. 15. Table summarizing temperatures at various stages of viscosity measurement for various flour/starches.

FIG. 16. Table summarizing viscosity data at various stages of measurement for various flour/starches.

FIG. 17. Table summarizing viscosity data at various stages of measurement for various flour/starches.

FIG. 18. Table summarizing viscosity data at various stages of measurement for various flour/starches.

FIG. 19. Pictorial representations of examples of breads prepared from gluten-free formulations of the present invention: (a) gluten-free cinnamon raisin bread (b) gluten-free white bread (c) gluten-free multigrain bread with millet and flax.

### DETAILED DESCRIPTION OF THE INVENTION

The present invention describes compositions for gluten-free bread and cake formulations. In one embodiment, a formulation for bread bakery products comprises gluten-free starch and/or flour, protein, hydrocolloid, yeast, emulsifier, water, and optionally, chemical leavening agents, sweetener, fat, flavors or inclusions, or acidulant. In another embodiment, a formulation for cake bakery products comprises gluten-free starch and/or flour, protein, hydrocolloid, emulsifier, water, fat, chemical leavening agent and optionally, sweetener, flavors or inclusions, or acidulant. In one embodiment, the formulation does not contain dairy ingredients and/or soy and/or or wheat ingredients.

The formulations can be used for breads, cakes, muffins and biscuits. In the bread formulation embodiment, the batter formulation and baked products resulted in a structure similar to regular wheat based yeast leavened baked products. The baked product made with compositions of the present invention does not have off flavor and has a clean flavor similar to that of regular wheat based yeast leavened baked products. The texture and baked specific volume is similar to that of white bread.

To yield baked products with desirable qualities, the compositions of the present invention comprise hydrocolloids but do not require additional polymers with gas-retaining and/or setting properties such as butadiene-styrene rubber, isobutylene-isoprene copolymer (butyl rubber), paraffin, petroleum wax, synthetic petroleum wax, polyethylene polyisobutylene, polyvinylacetate, poly-1-vinylpyrrolidione-co-vinylacetate copolymer, polyvinyl alcohol, polyethylene glycol, polyethylene oxide, polyarcylic acid, Sapteaceae (chicle, chiquibul, crown gum, gutt hang kang, massaranduba balata, massaranduba chocolate, nispero, rosidinha (rosadinah) and Venezuelan chicle), Apocynaceae (jelutong, leche caspi (sorva), pendare and perillo), Moraceae (leche de vaca, niger gutta and tunu (tuno)), Euphorbiaceae (chilte and natural rubber), poly acetic acid, polycaprolactone, and the like. Thus, in one embodiment the present invention provides a composition free of the aforementioned polymers.

Without intending to be bound by any particular theory, it is considered that the desirable qualities of baked goods prepared from compositions of the present invention result from use of starches having particles size distributions and amylose/amylopectin content similar to that of wheat starch.

In one embodiment, all ingredients used are natural ingredients thereby providing an all-natural gluten-free and diary-free formulation. In this embodiment, only natural emulsifiers are used.

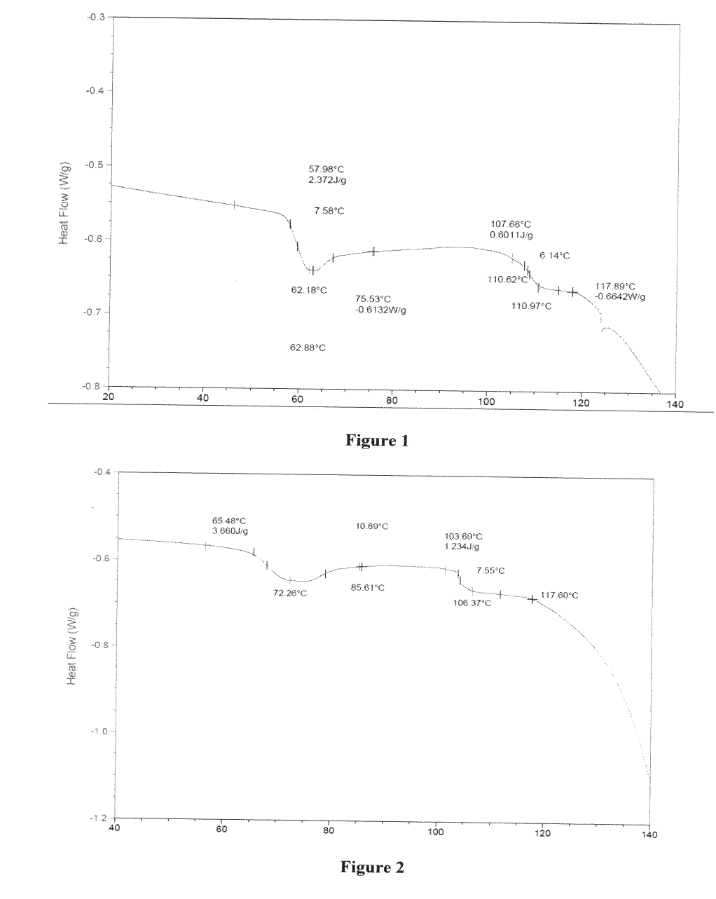

The present invention uses a starch blend that mimics the characteristics of wheat starch granules. Wheat starch has A & B type granules that gelatinize over a broad range of temperature. This invention uses a starch blend which mimics wheat starch in this aspect. DSC thermograms show that a starch/starch blends used in the formulations of the present invention gelatinize like wheat starch. Examples of DSC thermograms are shown in FIGS. 1 and 2.

In one embodiment, the formulations of the present invention comprise starch or starches where at least 50% of the starch granules are 18 microns or less. In various embodiments, at least 50% of the starch granules are 20, 19, 17, 16, or 15 microns or less in size. In another embodiment, the formulations comprise starch or starches where at least 80% of the starch granules are 28 microns or less in size. In various embodiments, at least 80% of the starch granules are 30, 29, 27, 26, 25, 24, 23, 22, 21 or 20 microns or less in size. In yet another embodiment, the formulations comprise starch or starches where at least 90% of the starch granules are 35 microns or less in size. In various embodiments, at least 90% of the starch granules are 37, 36, 34, 33, 32, or 31 microns or less in size.

In another embodiment, the formulations of the present invention comprise starch or starches where the volume weighted mean of the starch granules size is 27 microns or less. In various embodiments, the volume weighted mean of the starch granules size is 45 to 15 microns, including all integers between 45 and 15 microns, or less.

The ratio of amylose to amylopectin varies, depending on the source of the starch, and is a major contributor to a starch's functional properties. Corn starch, for example, has around 24% amylose and 76% amylopectin, while potato starch has 20% amylose 80% amylopectin. Tapioca only has about 17% amylose and waxy maize or waxy brown rice have virtually none. Starches or starch blends useful in the present invention have the similar amount of amylose and amylopectin as in native wheat starch (which typically has 25% amylose) which may contribute to mimicking the organoleptic properties of regular white bread. Also, it is considered that the emulsifiers and the fat used in the system aid in producing networks similar to those which are achieved in baked wheat flour. Thus, this invention provides compositions and method used to make gluten-free, wheat-free, soy-free and dairy-free cake and bread. The resultant bread and cake have texture properties and baked specific volumes comparable to conventional breads and cakes.

In one embodiment, the starch/starch blend used in the formulation has 20% to 30% amylose. In another embodiment, starch/starch blend used in the formulation has 25% amylose.

In various embodiments, the components of the formulation include, but are not limited to, the following:

Starch. The starch system (which can include flour, starch, and mixtures thereof) of the present invention is selected such that its properties mimic the gelatinization of wheat starch (as evidenced by DSC comparison with wheat starch—FIGS. 1 and 2). Also, the starch granules mimic the A-type and B-type starches of wheat starch. Wheat starch has starch granules with bimodal size distribution. In the present invention, it is desirable to use starch/starch blends with starch granules having a bimodal (or multimodal) size distribution similar to that of wheat starch. The starch granule size distribution is shown by particle size analysis. However, a starch system by itself was not able to produce acceptable bread, as evident from Comparative Example 1. Suitable starch sources for the present invention include, but are not limited to: tapioca flour (tapioca starch), modified tapioca starch, rice flour, potato starch, corn starch, amaranth flour, quinoa flour, garbanzo flour, bean powder, millet flour, sorghum flour, teff flour and the like.

Corn starch is a necessary component of the formulation. An example of a suitable corn starch is dent corn starch. Dent corn (also known as “field corn”) is a variety of corn which is higher in starch and lower in sugar than table corn, the type of corn eaten as a vegetable. In one embodiment, only corn starch is used in the formulation. In another embodiment, corn starch is combined with additional starch or starches (such as modified tapioca starch, potato starch and rice flour). In one embodiment, the corn starch comprises 10 to 30% of the formulation, including all integers and 0.1% between 10 and 30%. In another embodiment, the corn starch comprises 10 to 26% of the formulation, including all integers and 0.1% between 10 and 26%. In another embodiment, the corn starch is dent corn starch.

In one embodiment, the water holding capacity of the starch/starches in the formulation is 65 to 75%, including all integers between 65 and 75%, at 25° C.

Protein. Proteins provide emulsification properties that help in retaining the gas produced during proofing and contributing to the structure during baking. Comparative Example 1 lacks any protein source and this formulation resulted in low baked volume, dense texture and lack of any mouth-feel. Suitable proteins for the present formulation include, but are not, limited to, gelatin, soy protein, milk protein, powdered and/or liquid egg whites, egg yolk and whole eggs, and the like. The protein can also be a mixture of proteins.

In one embodiment, the formulation does not contain dairy protein. In another embodiment, the formulation contains dairy protein.

Hydrocolloid(s) (also referred to herein as “gum(s)”). Hydrocolloids are water-dispersible, non-starch hydrophilic materials which are able to increase the viscosity of aqueous systems as a result of their ability to absorb water. Hydrocolloids can be linear or branched and neutral or charged. Suitable hydrocolloids include both naturally occurring gums and synthetic materials. It is considered that in the absence of gluten, the hydrocolloid system helps in holding water in the batter while retaining machineability and holds water in baked product giving it a moist mouth-feel. It is desirable that the amount of hydrocolloid used provides the right viscosity to hold the fermentation gases while expanding in the process. A suitable level for this purpose is up to 5%. If a higher level is used, the structure becomes too rigid to expand during proofing and baking. A higher hydrocolloid amount also results in the mouthfeel of the bread being too chewy.

Examples of suitable hydrocolloids include, but are not limited to, gums such as guar gum, xanthan gum, pectin, locust bean gum, gum acacia, carageenan, konjac, and synthetic materials such as methylcellulose, hydroxypropylmethylcellulose, carboxymethylcellulose, and the like. Also, mixtures of hydrocolloids can be used. Generally, it is desirable to use hydrocolloids which are instantly solublized but develop viscosity at different stages in the baking process.

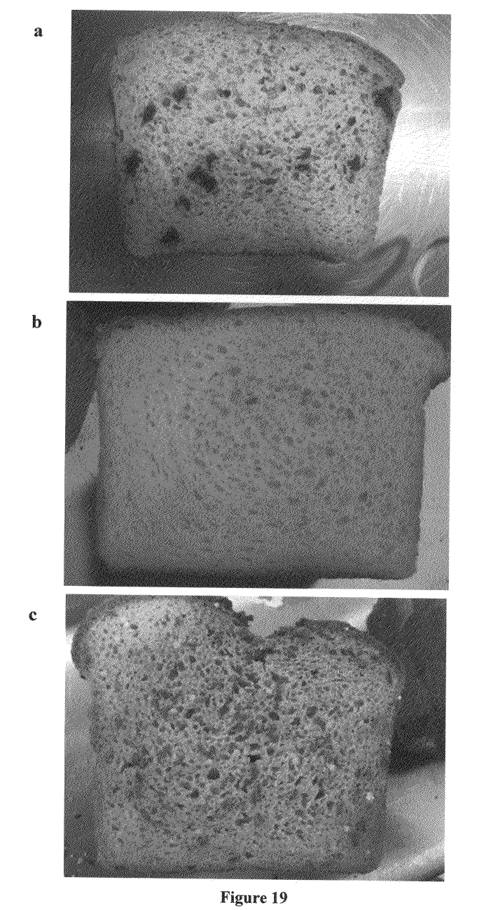

For example, the hydrocolloids are selected such that inclusions (such as fruity pieces (e.g., raisins), flavor chips, grains, seeds, and the like) are suspended uniformly throughout the product (see FIGS. 19 (a) and (c)).

In one embodiment, the amount of hydrocolloid in the bread formulation is from 0.1 to 10%, including all percentages to the tenth decimal between 0.1 and 10%. In another embodiment, the amount of hydrocolloid in the cake formulation is from 0.15 to 5%, including all percentages to the tenth decimal between 0.15 and 5%.

An example of a suitable blend of hydrocolloids which achieves desired batter viscosity at different stages of processing is provided below:
Xanthan gum—hydrates quickly and increases viscosity during proofing. This is considered to help in entrapment of the gas molecules during mixing and proofing. An example of suitable particle size is about 200 microns which hydrates in about 2 minutes. Xanthan is shear thinning, so under mixing conditions a solution of xanthan would be low viscosity. The highest viscosity of a xanthan solution is developed under rest conditions like proofing. In the absence of xanthan gum, the breads and cakes lacked volume resulting in gummy and dense texture.
Guar gum—a heat activated gum that is considered to increase viscosity during initial stages of baking, resulting in entrapment of the steam and CO₂ generated. Guar aids in developing an open texture and volume similar to that of white bread. The viscosity developed also prevents coalescence of the steam and CO₂ generated during baking. This results in numerous air cells rather than huge isolated aircells.
Pectin—helps in developing networks by interacting with the proteins present in the system. In the absence of gluten, it is considered that protein-pectin interactions are critical for the baked structure of the bread or cake. It is believed that pectin contributes to creating the firm structure of the batter during proofing. Although not intending to be bound by any particular theory, it is possible that pectin is hydrated during proofing and formed a protein complex prior to guar hydration and methylcellulose gel formation. In the absence of pectin, the batter exhibited a lack of structure/rigidity. Also, in the absence of pectin the baked bread collapsed during cooling further supporting the premise that pectin-protein networks provide structure to the bread.
Methyl cellulose—it is considered that this hydrocolloid gels during baking and therefore helps in entrapping the gases generated during baking and the film forming properties strengthen the cell walls and avoid falling of the structure during processing. As a result, it may strengthen the cell structure of gluten-free breads. Methyl cellulose also contributes to improvement of the batter consistency. Additionally, the film forming abilities of methyl cellulose may protect other ingredients during mixing.

In one embodiment of the composition, Pectin, xanthan and Methocel™ (a hydroxypropyl methylcellulose) are used in equal proportions. In this embodiment, guar gum is used at half the concentration of the other gums.

Emulsifiers. It is desirable that the emulsifier used in the formulation work in three (3) phase interfaces. The batter is an oil-in-water dispersion with air suspended in it. Suitable emulsifiers include, but are not limited to, lecithin, monoglycerides, sodium steroyl-2-lactylate (SSL), DATEM, polysorbates and propylene glycol esters of fatty acids, and the like. Mixtures of emulsifiers can be used.

Leavening Agents. For breads, the leavening agents can be chemical leavening agents and/or yeast. For cakes, only chemical leavening agents are required and therefore, there is no need for proofing. An example of a suitable chemical leavening agent concentration is 1% active dry yeast in conjunction with 0.5% of double acting baking powder. The double acting baking powder reacts in 2 stages, one during mixing and second, subsequently, during baking.

In a cake embodiment, a different leavening system is used as the process of structure setting is different in cakes than in breads.

Optional components of the formulations of the present invention include:

Fats. The fat used in this invention at least in part ensures that the air incorporated during mixing is trapped in the batter system. Suitable fats include both plastic fats (also referred to as shortening) and liquid fats. Plastic fats include hydrogenated (or partially hydrogenated) oil-based shortening and non-hydrogenated oils. Examples of shortenings include, but are not limited to, those made of palm oil, palm kernel oil, coconut oil, canola oil, cottonseed oil, and the like. Examples of liquid fats include, soy oil, canola oil, coconut oil, vegetable oil, cottonseed oil, and the like. It is considered that use of plastic fats, such as shortenings, in the formulations resulted in incorporating more air than using soy or canola oil. In some embodiments, it was found that plastic fats worked better than liquid fats. Butter and margarine can also be used. Mixtures of fat can also be used.

Sweetener System. In the cake embodiment, the sweetener system is critical for the moist mouthfeel of the cakes. In the present invention, sugar can be successfully replaced with other sweeteners such as corn syrup solids, fructose, glucose, dextrose, honey and the like. The mouthfeel of the cake can be modified using different combinations and levels of sweeteners. Non-caloric sweeteners can also be used in the formulations of the present invention. Examples of non-caloric sweeteners include, but are not limited to, aspartame, sucralose, saccharin, neotame, acesulfame potassium, stevia, and the like.

Other Ingredients. In various embodiments, the gluten-free compositions comprise other ingredients such as, but not limited to, dough conditioners, shelf-like extenders, enzymes (e.g., Bake-Soft® which is an enzyme based shelf-life extender for yeast leavened baked products) and anti-staling agents. It is considered that rice bran isolate or rice bran extract acts as a natural dough conditioner—the pentosans improve water holding capability that impacts batter viscosity. Also, the glycolipids provide emulsification and water distribution. Together these improve the texture and shelf life of the product. In some embodiments, rice bran isolate (or extract) was found to perform better than rice bran. Enzymes also include softening enzymes (e.g., amylase which breaks down starch and helps in increasing the oven spring and softness in fresh bread, also acts as an anti-staling agent, and ensures longer shelf life for the bread), xylanase and hemicellulase (which degrade the linear polysaccharide beta-1,4-xylan into xylose, thus breaking down hemicellulose which releases bound water and improves loaf volume, and crumb structure).

Other ingredients also include acidulants, such as fumaric acid, acetic acid and citric acid, which can be used alone or in combination. These organic acids help in altering the final pH of the product helping in extending the shelf life. Also, it is considered the acids hydrolyze the starch polymers that are leached during baking resulting in softer baked products. It is also considered that the acids also help in retarding starch recrystallization during storage thereby slowing the retrogradation process.

In one embodiment, the acidulant comprises 0.1 to 0.5 weight percent of the formulation, including all 0.1% between 0.1 and 0.5 weight percent. In another embodiment, the formulation comprises an acidulant selected from the group consisting of fumaric acid, acetic acid, and combinations thereof. In a preferred embodiment, the formulation comprises fumaric acid.

In one embodiment, compositions are used to prepare bread and similar baked products. Thus, in one aspect, the present invention comprises bread bakery products produced from the formulations disclosed throughout this application.

Provided below is the overall composition for a bread formulation.

TABLE 1

| | range for | preferred |
|---|---|---|
| Ingredient | wt % | wt % range |
| gluten-free flour or starch | 15-50 | 20-40 |
| protein | 1-10 | 2-7 |
| hydrocolloids | 0.1-10 | 0.5-4.0 |
| yeast | 0.5-5 | 1-3 |
| chemical leavening agents | 0-5 | 0.2-2.0 |
| emulsifiers | 0.5-5 | 1-4 |
| sweetener system (e.g. sugar) | 0-15 | 2-10 |
| dough conditioners and anti-staling | 0-7 | 0.1-5 |
| agents (including enzymes) | | |
| salt | 0.2-2.5 | 0.5-2.0 |
| acidulant | 0.1-5 | 1-3 |
| water | 25-50 | 30-46 |
| flavors and/or inclusions | 0-25 | 0-20 |
| fat | 0-12 | 3-9 |
| Total | 100 | 100 |

As an example, the formulation can be prepared using the following steps:
1) Mixing. In the present invention, all dry ingredients can be added in at once or one after another instead of addition of leavening at the end of the mix. Dry ingredients are mixed at ambient temperature. An example of suitable water temperature in the present invention is 105 to 110° F. Use of a suitable water temperature activated the yeast and hydrated the gums in the system well. Without proper hydration of the gums, the bread lacked the desired structure. The resultant bread was gummy and collapsed after baking.
2) Process after Mixing. (a) Scale to appropriate amounts (Pup loaves 250 g); (b) Proof for 45 to 60 minutes at 90° F./85% Relative Humidity (RH). These proofing conditions are lower than the Comparative Example process proofing conditions (115° F./85% RH). The higher temperature using the Comparative Process in Example 1 resulted in leavening in only 15 minutes to proof to 1 inch above the pan. Use of ambient temp in the present invention caused the bread to take 45 minutes.
3) Baking. The bread loaves were baked at 330° F. with 10 seconds of steam for 20 to 35 minutes based on size.

In one embodiment, the bread formulation comprises combinations of the ingredients set out in Table 1. In another embodiment, the bread formulation consists essentially of combinations of the ingredients set out in Table 1. In yet another embodiment, the bread formulation consists of combinations of the ingredients set out in Table 1.

In one embodiment, a bread formulation comprises xanthan gum, guar gum, pectin, and methyl cellulose.

In another embodiment, the compositions of the present invention are used to prepare cake and similar baked products. Thus, in one aspect, the present invention comprises cake bakery products produced from the formulations disclosed throughout this application.

Provided below is an overall composition for a cake formulation.

TABLE 3

| | range | preferred |
|---|---|---|
| Ingredient | (wt %) | range (wt %) |
| Gluten-free flour or starch | 10-35 | 15-25 |
| Protein | 1-10 | 2-6 |
| Hydrocolloids | 0.15-5 | 0.2-2 |
| chemical leavening agents | 0.5-4.5 | 1-3 |
| emulsifiers | 0.2-5 | 0.5-3.5 |
| sugar | 15-50 | 25-45 |
| water | 15-50 | 20-45 |
| Fat | 2-12 | 3-9 |
| Flavors | 0-5 | 0.25-3 |
| Total | 100 | 100 |

In one embodiment, the cake formulation comprises combinations of the ingredients set out in Table 3. In another embodiment, the cake formulation consists essentially of combinations of the ingredients set out in Table 3. In yet another embodiment, the cake formulation consists of combinations of the ingredients set out in Table 3.

In one embodiment, the cake formulation comprises:

TABLE 4

| Ingredients | wt % |
|---|---|
| potato starch | 5.00 |
| sugar | 28.50 |
| PGME + SSL | 1.50 |
| corn syrup solids | 2.65 |
| rice flour | 9.33 |
| modified corn starch | 4.12 |
| baking soda | 0.65 |
| leavening acid | 0.83 |
| salt | 0.70 |
| hydroxymethyl propyl cellulose | 0.35 |
| fiber | 0.35 |
| tapioca flour | 2.82 |
| powdered egg whites | 2.00 |
| liquid whole eggs | 12.00 |
| liquid egg whites | 14.50 |
| water | 14.70 |
| Total | 100.0 |

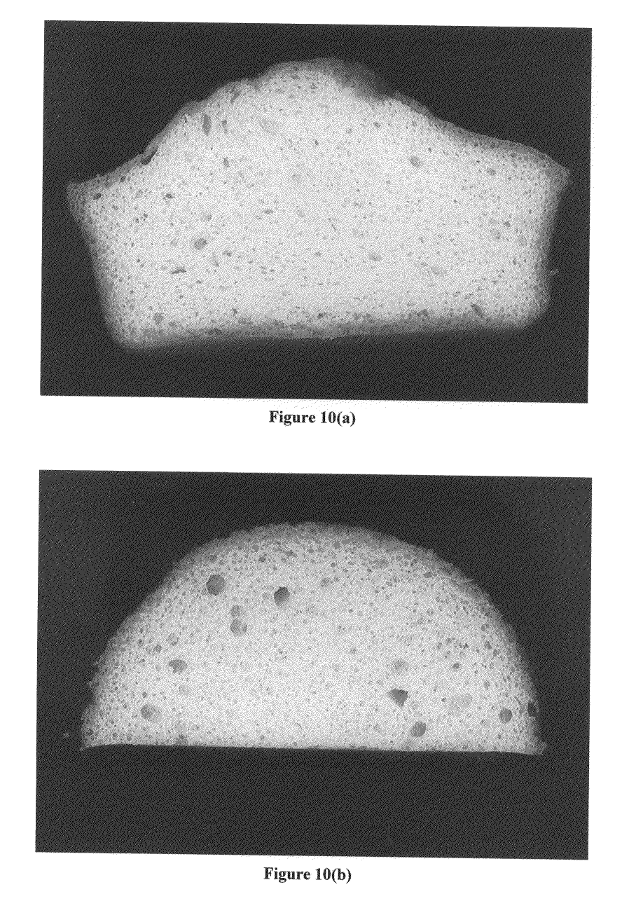

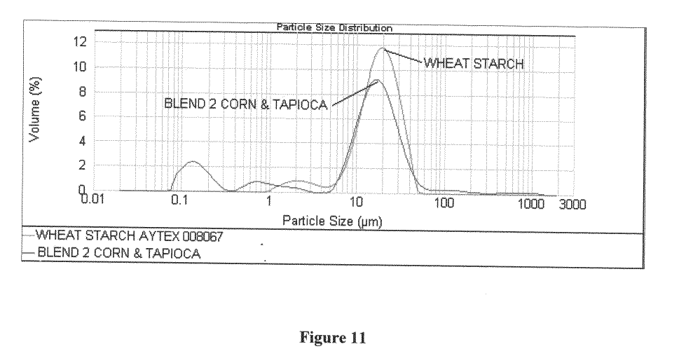

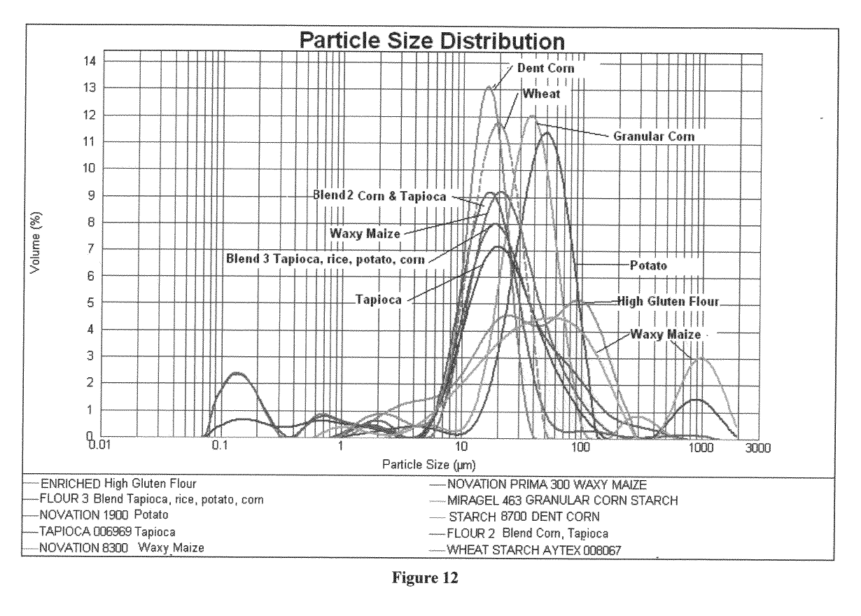

The appearance of a cake prepared from a formulation of this embodiment is shown in FIG. 10. In this embodiment, if chocolate cake is desired, the rice flour can be replaced with cocoa powder.

In one embodiment, the cake formulation comprises the ingredients set out in Table 4, except that 0.2 weight percent acetic and/or fumaric acid is included in the formulation and the water is present at 14.5 weight percent.

The following examples are presented to illustrate the present invention. They are not intended to limiting in any manner.

### Example 1

The following is a comparison of the formula and process of the present invention with a comparative formulation and process.

A comparative formulation was prepared according to the formula of Table 5.

TABLE 5

| | Percent by |
|---|---|
| Ingredient | weight (% wt) |
| salt | 0.13 |
| sugar | 0.13 |
| wheat starch | 37.87 |
| gucono delta-lactone (GDL) | 2.52 |
| sodium bicarbonate | 1.26 |
| sater | 53.65 |
| ammonium bicarbonate | 0.31 |
| soybean oil | 1.68 |
| lehithin | 0.5 |
| xanthan gum | 1.58 |
| diacetyl tartaric acid esters of mono- | 0.16 |
| and diglycerides | |
| azodicarbonamide | 0.02 |
| ascorbic acid | 0.02 |
| sodium stearoyl lactylate | 0.16 |
| Total | 100 |

In the comparative process, the ingredients, except for the chemical leavening agents, were mixed for 3 minutes on high speed in a mixer with a paddle. The chemical leavening agents were then added, and the batter was mixed on high speed for an additional 3 minutes. The resulting batter was sticky. Approximately 220 g of batter were poured into a pup loafpan. The batter was proofed to approximately 1 inch above the top of the pan, at 115° F. and 85% relative humidity. The batter was then baked for 30 minutes at 430° F.

A comparison was made between the present formulation and process and the comparative formulation and comparative process. The results are presented in the table below.

TABLE 6

| | | | | | | | | | Specific |
|---|---|---|---|---|---|---|---|---|---|
| | Weight | Volume | Height | Width | Depth | DepthC | MaxD | Area | Volume |
| Set I | | | | | | | | | |
| present | 225.06 | 662 | 147 | 84 | 95 | 81 | 101 | 53 | 2.94 |
| formula; | | | | | | | | | |
| present | | | | | | | | | |
| process | | | | | | | | | |
| comparative | 221.36 | 464 | 138 | 86 | 72 | 64 | 91 | 44 | 2.10 |
| formula; | | | | | | | | | |
| present | | | | | | | | | |
| process | | | | | | | | | |
| present | 167.78 | 739 | 160 | 154 | 118 | 93 | 173 | 62 | 4.40 |
| formula; | | | | | | | | | |
| comparative | | | | | | | | | |
| process | | | | | | | | | |
| comparative | 167.12 | 510 | 145 | 81 | 85 | 72 | 89 | 42 | 3.05 |
| formula; | | | | | | | | | |
| comparative | | | | | | | | | |
| process | | | | | | | | | |
| Set II | | | | | | | | | |
| present | 223.48 | 673 | 148 | 86 | 94 | 81 | 102 | 54 | 3.01 |
| formula; | | | | | | | | | |
| present | | | | | | | | | |
| process | | | | | | | | | |
| comparative | 220.0 | 476 | 142 | 84 | 73 | 66 | 91 | 44 | 2.16 |
| formula; | | | | | | | | | |
| present | | | | | | | | | |
| process | | | | | | | | | |
| present | 166.76 | 780 | 147 | 123 | 191 | 94 | 191 | 64 | 4.68 |
| formula; | | | | | | | | | |
| comparative | | | | | | | | | |
| process | | | | | | | | | |
| comparative | 166.12 | 537 | 278 | 160 | 106 | 72 | 172 | 44 | 3.23 |
| formula; | | | | | | | | | |
| comparative | | | | | | | | | |
| process | | | | | | | | | |

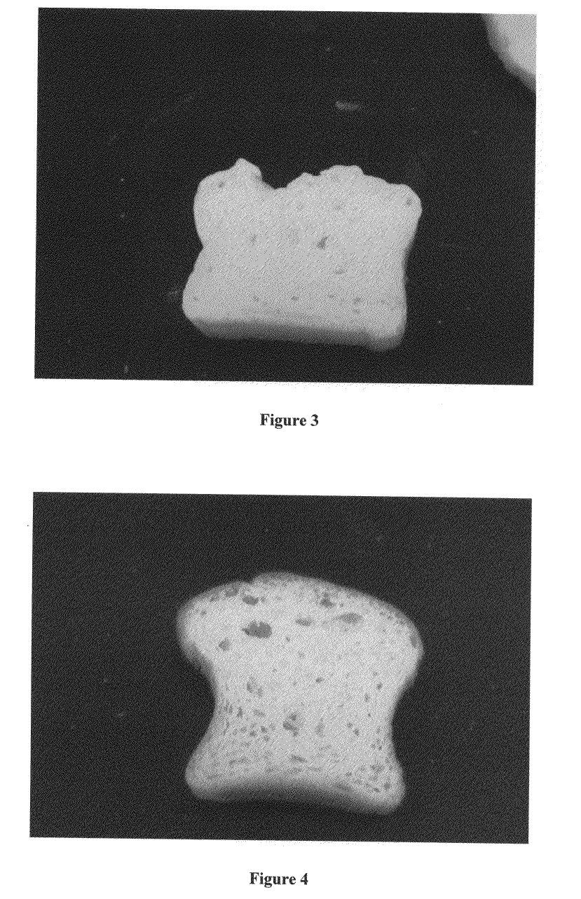

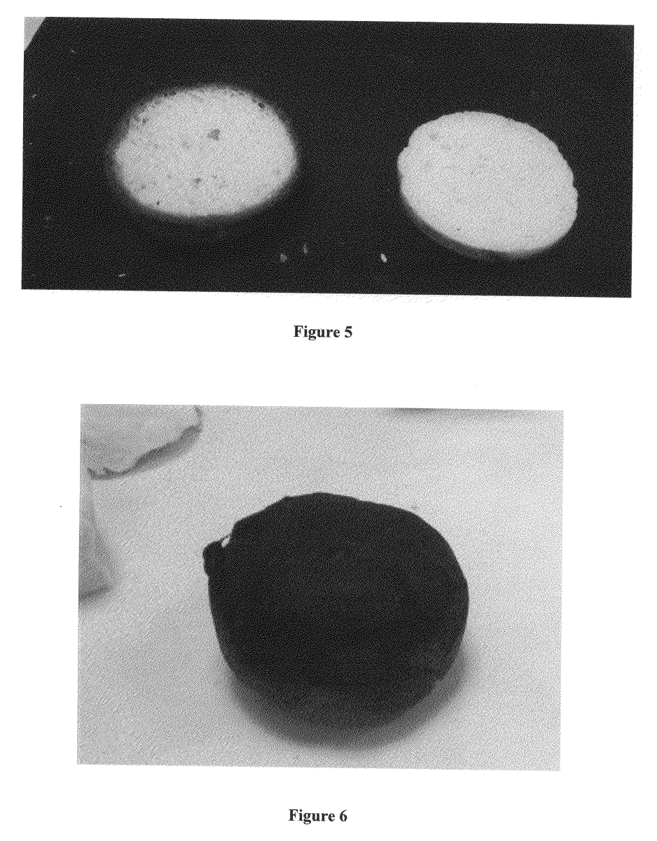

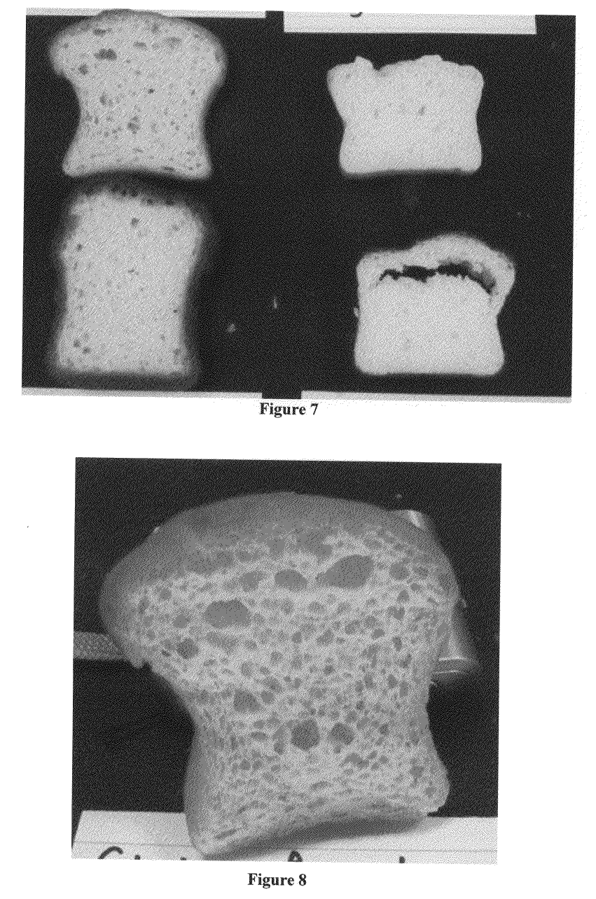

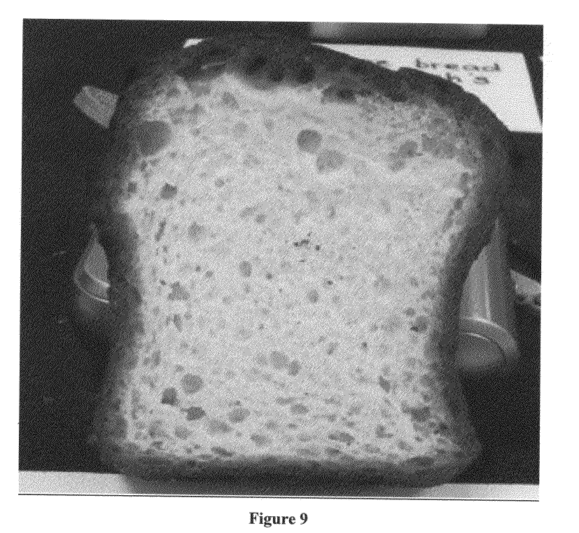

As can be seen, the present formula achieved a higher baked specific volume compared to the comparative formula 1 when used with the comparative process. However, the texture and appearance of the baked product was not desirable because it had a burnt appearance. FIGS. 2-8 are representations of pictures showing the combination of present formulation, present process and the comparative formulation and comparative process.

### Example 2

This example describes bread formulations of the present invention.

TABLE 7

| | Formula | Formula |
|---|---|---|
| Ingredient | 2 (wt %) | 3 (wt %) |
| modified tapioca starch | | 5 |
| tapioca flour | 12 | 5 |
| rice flour | | 5 |
| potato starch | | 15 |
| dent corn starch | 22 | 10 |
| egg white | 3 | 3 |
| Maltodextrin | 2 | 2 |
| Rice Bran Isolate | 1 | 2 |
| guar gum | 0.2 | 0.7 |
| xanthan gum | 0.5 | 0.5 |
| fat and/or vegetable oil | 5 | 5 |
| SSL | 0.1 | 0.1 |
| emulsifier (monoglyceride) | 1.5 | 1.5 |
| enzymes | 100 ppm | 100 ppm |
| sugar | 5 | 5 |
| yeast food | 0.2 | 0.2 |
| acetic acid/fumaric acid | 0.3 | 0 |
| yeast | 1 | 1.5 |
| salt | 1 | 1 |
| water | 44.2 | 37.5 |
| Total | 100 | 100 |

### Example 3

This example describes formulations for gluten-free cakes. A formulation is provided for making “high ratio gluten free cakes”—meaning that there is more sugar in the formula than flour. It is important to use a combination of flours and starches that replicate the changes that take place during the baking of wheat flour.

As indicated above, the starches and flours used for this formulation were selected so as to have similar gelatinization properties as that of wheat starch. The types of starches and their quantities affect the organoleptic properties of baked cake. Even if the right combination of starches is used but the ranges are varied beyond the desired level, it still results in a cake. But the resultant cake lacks the desired mouthfeel of a cake. When the ranges of the starches and flours are varied, the resultant product is denser and/or chewier than typical cake. Typically, bleached soft wheat flour is used for making cakes. But in order to get an acceptable gluten-free cake, a combination of soft and hard flours or starches extracted from soft and hard flours were used. The unique combination of flour is similar to the flour from wheat milling. The flour composition of this invention bakes like wheat flour and is not limited by the amount the sugar used in the system. However, to get similar properties to high ratio cakes, it is important to maintain a balance of the rest of ingredients in the system. The present invention works well with inclusions of all sorts and therefore can be used for making specialty cakes like carrot cake and the like. The unique combination of starches and flours can also be used in making other chemical leavened products such as muffins and biscuits. Suitable starches include corn starch, modified corn starch, tapioca starch, potato starch, rice flour. The total amount of starches/flours used is in the range of 10-35%. Preferably, the corn starch is the highest component of the starch/flour blend. It is considered that tapioca starch, potato starch and/or rice flour compliment corn starch well.

Fats and emulsifiers. The emulsifier and fat system used in the cake embodiment at least in part ensures that the air incorporated during mixing is trapped in the batter system. The fat and emulsifiers combination and ratio used in this invention plays an important role in the texture and mouthfeel of the cake. The emulsification system ensures that the size of gas molecules is uniform and populous. If the appropriate emulsification system is not used, this results in tunnels through the cake and coalescence of gas molecules resulting in very open cell structure. It is desirable that the emulsifier used in this formulation work in 3 phase interfaces. A cake batter is oil in water dispersion with air suspended in it. Emulsifiers that were found suitable for this invention include lecithin, monoglycerides, SSL polysorbates and propylene glycol esters of fatty acids. It is important to use the appropriate level of emulsifiers. If too little emulsifier is used, then the air bubbles are not stabilized and can coalescence resulting in big air bubbles and non uniform cell structure in the cake. If too much emulsifier is used, it overstablizes the system causing a collapse of the structure during baking. The preferred range of emulsifiers is 0.5-3.5%. In this case, it was found that plastic fats worked better than liquid fats. Plastic fats such as shortenings helped in incorporating more air than using liquid fats such as soy or canola oil. The shortenings used in this application are made of palm oil, coconut oil, canola oil and/or cottonseed oil.

Leavening system. The leavening system used in this system, reacts in-sync with the flour gelatinization. This ensures that the right amount of gases at the different stages of processing. A part of the leavening system reacts during mixing and creates nuclei for more gas production. An example of a leavening system used is: monocalcium phosphate, sodium acid pyrophosphates with different reaction rates and sodium aluminum phosphate (SALP). If all the gas is generated before the cake structure is set, the resultant cake will lack desired volume and have dense texture. Therefore, it is desirable to use a leavening system that works with the changes taking place during starch gelatinization.

Sweetener System. The sweetener system used in cakes is important for the moist mouthfeel of cakes. In the present invention, a part of sugar can be successfully replaced with other sweeteners like corn syrup solids, fructose, glucose and dextrose, honey and non-caloric sweeteners (such as aspartame, sucralose, saccharin, neotame, acesulfame potassium, stevia, and the like). The mouthfeel of the cake can be modified using different combinations and levels of sugars.

Gums/Hydrocolloids. The hydrocolloid system used in this formulation generates viscosity at different stages in processing. This gives good machineability to the cake batter. It is considered that the gum system generates some viscosity during batter mixing entrapping the gas molecules added to the batter. Additional viscosity is generated during baking which ensures that the gases generated during baking. It is also desired that the gum system used preferably has film forming properties which strengthens the gas solid interfaces before and during baking. The gum system also helps in improving frozen shelf life by imparting freeze-thaw stability.

The formulation used in this invention mimics the rheological properties of traditional cake batter. Therefore, the present invention can be produced using the equipment similar to that used in traditional cake production.

Process specifics:
1. Temperature: In order to get uniform cell structure, it is important to use certain ingredients at the appropriate temperature. The appropriate temperature of certain ingredients such as whole eggs and water ensures that the right amount of air is incorporated during batter mixing and size of the incorporated air molecules is uniform. This results in cake with fine and uniform crumb structure. The temperature of the liquid whole eggs and the liquid egg whites should preferably be 34-40° F. The water temperature should be adjusted so that the final batter temperature is 50-65° F. This water temperature is not suited for bread as yeast will not activate. For example, when the bread batter temperature was around 60° F., the yeast suffered a cold shock and did not ferment well resulting in proper quality breads with gummy texture.
2. Mixing: In typical cake preparation, the sugars and fats are creamed together in order to incorporate more amount of air. In this invention, it was found that for gluten free cakes, creaming of sugar with fat did not give any significant advantage in baked volume. Therefore, it is not required that the present invention uses the same processing as typical wheat containing cakes.
3. Specific gravity: the mixing method adopted in this invention gives a batter with specific gravity in the range of 0.85-0.95. The amount of air incorporated during mixing dictated the ease of machineability of the batter. The specific gravity of the batter determined the cell structure of the baked cake and the baked specific volume.
4. Floor time: The present invention is not sensitive to time and temperature before processing. As a result, it offers comparable floor time to conventional cake batter
5. Process time: Since the present invention mimics baking using wheat flour, it does not take longer processing times. In other words, the process times are the same as wheat flour.
6. Freezer to oven: The present invention can be used to make freezer to oven cakes. The cake batter can be frozen after mixing and then baked while it is still frozen.
7. Processing: The present invention does not require specific processing or equipment and therefore can be easily manufactured on existing cake equipment in manufacturing plants.

The present invention is different than already available products in the market for at least the following reasons:
Baked products of the present invention do not have gummy and gritty mouth feel.
The present formulations include cake mixes which when made into cakes have freezer stability.
Formulations of the present invention have a frozen shelf life of 120 days and 10 days refrigerated shelf life.
Gluten-free cakes of present invention have the same texture, mouthfeel and appearance of regular cake.
Formulations of the present invention can be used in freezer to oven applications.
Formulations of the present invention have great machineability.
Gluten free cake batter of the present invention has the same properties as conventional cake batter therefore same equipment can be used.

Typically, cakes are chemically leavened. Also, cake formulations generally have more sugar than the bread formulations. In the cake formulations, there is more sugar than starches. In the present invention, sugar to flour ratios in the range of 120-195% can be used. Further, the processing of cake formulations is different from that for bread formulations. For example, in processing cake formulations there is no proofing step, the batter is colder than bread (50-65° F.), and the cake batter, because of lack of yeast, is whipped to 0.85 specific gravity in order to ensure enough rise. Bread batters typically have specific gravity in the range of 0.95-1.05.

### Example 4

This example provides starch granule size data for compositions of the present invention.

All ingredients (dry powders) were measured in a Malvern Mastersizer particle size analyzer. Distilled water (70° F.) was used as a medium for dispersing the dry starch materials. A small sample of the ingredient (starch/flour) was added to the water and subjected to ultrasonic vibration for 1 minute. The resulting dispersed powders passed through a recirculation cell across a laser beam. The granule particle size was measured via laser diffraction and calculated based on the Mie theory.

TABLE 8

| | | | | D [4, 3]- |
|---|---|---|---|---|
| Type of Starch or | | | | Vol. wght |
| Flour | d (0.5) | d (0.8) | D (0.9) | mean |
| waxy maize | 22.962 | 42.544 | 61.302 | 30.848 |
| Blend 3 (tapioca, rice, | 23.03 | 54.55 | 92.164 | 42.859 |
| potato, corn starches) | | | | |
| enriched high-gluten | 37.007 | 99.882 | 137.789 | 57.247 |
| flour | | | | |
| granular corn starch | 36.364 | 55.499 | 69.856 | 50.114 |
| potato starch | 45.619 | 69.781 | 84.518 | 49.31 |
| Dent corn starch | 14.188 | 20.425 | 24.053 | 13.579 |
| tapioca starch | 21.7 | 50.435 | 116.634 | 112.458 |
| Blend 2 corn, tapioca | 14.74 | 25.204 | 33.419 | 24.882 |
| waxy rice | 55.321 | 210.962 | 950.852 | 240.127 |
| wheat starch | 17.919 | 27.019 | 32.463 | 19.061 |

All values in the table are expressed in microns. Blend 2 is the starch blend from Formula 2 in Example 2. Blend 3 is the starch blend from Formula 3 in Example 2.

### Example 5

This example provides a comparison of viscosity data for compositions including those of the present invention.

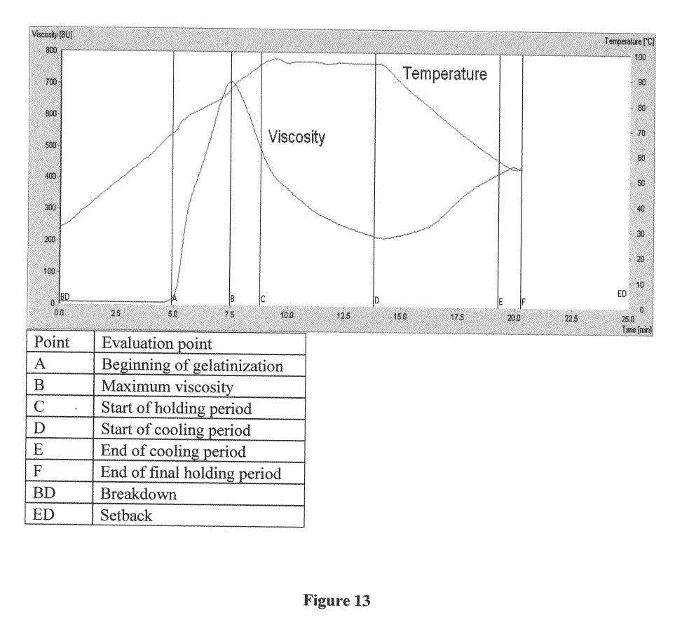

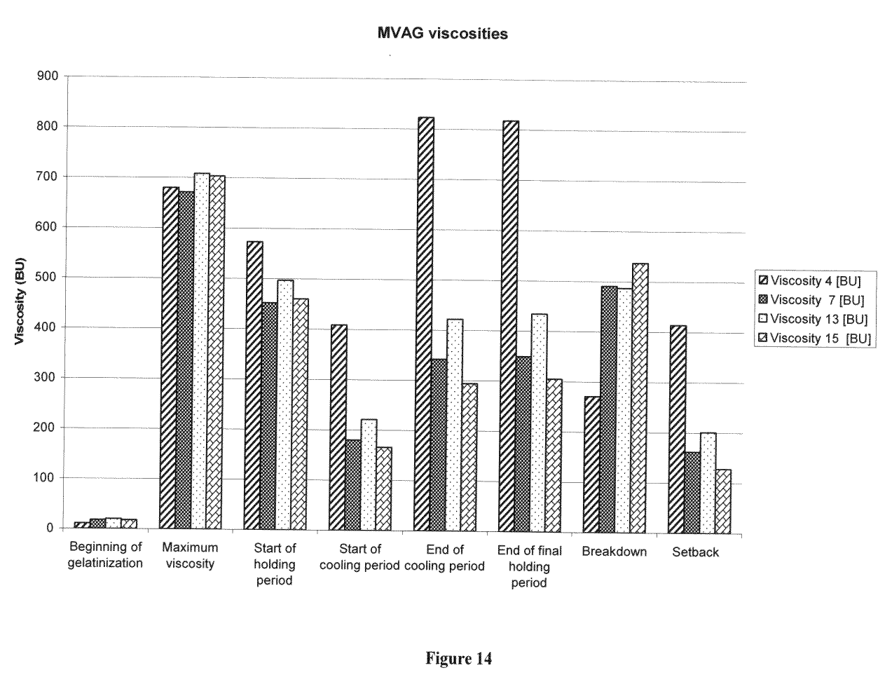

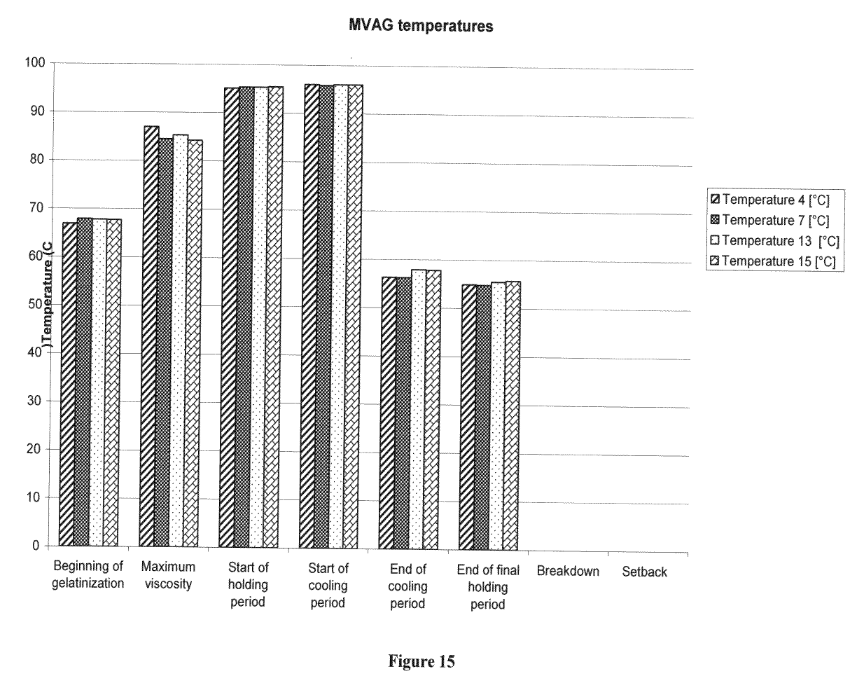

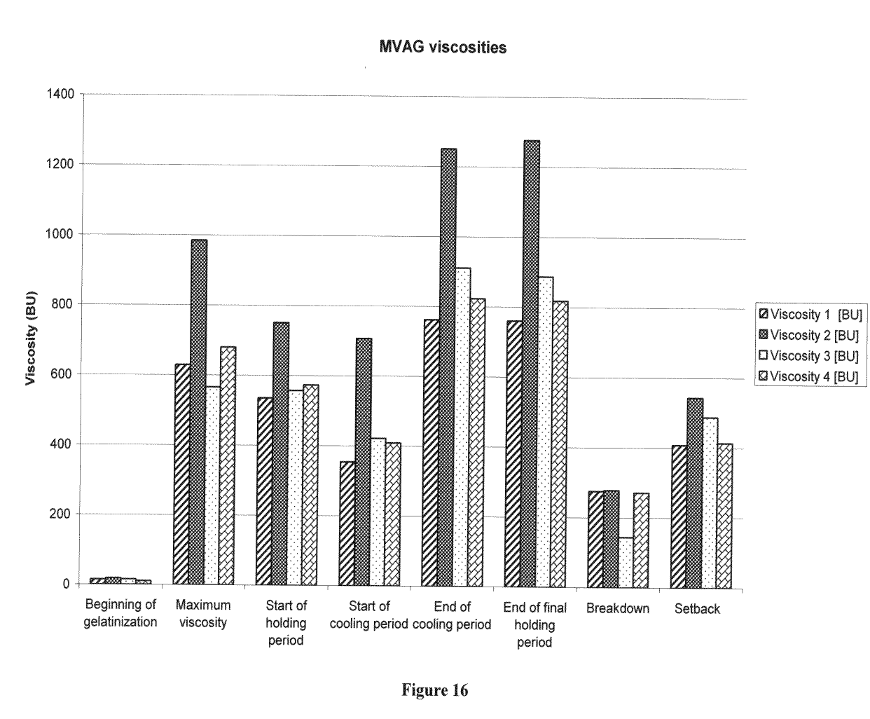

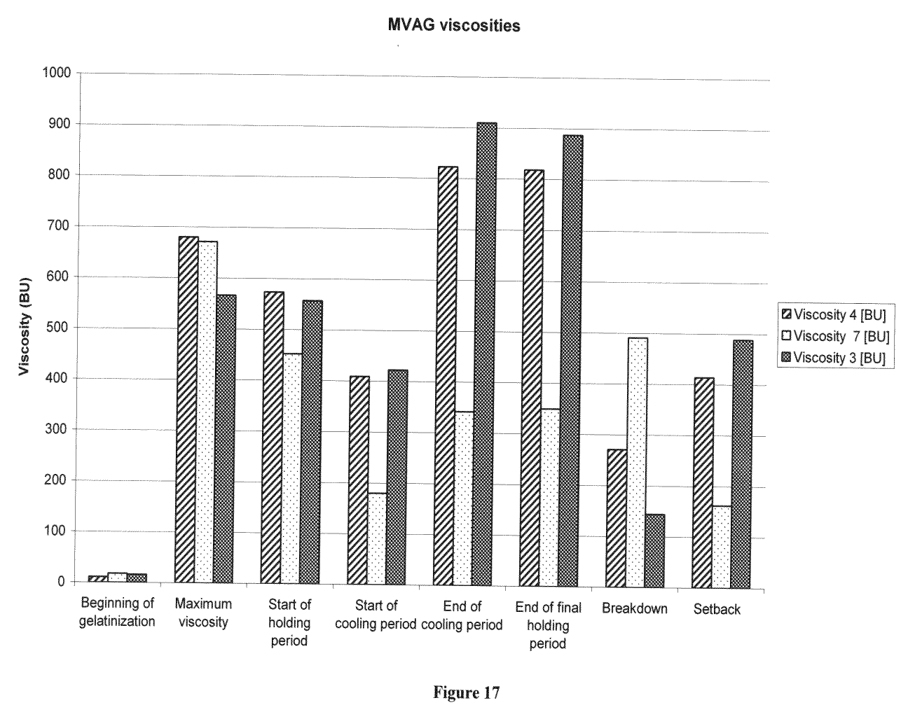

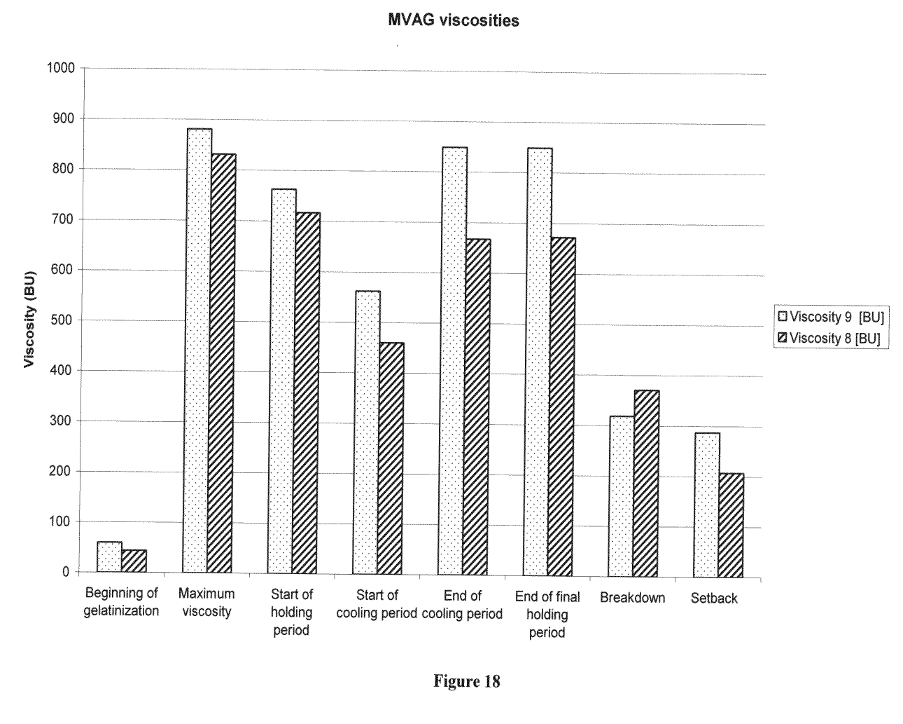

Method. A Brabender® Micro Viscoamylograph was used to measure the viscosity changes in a starch slurry heated and cooled to specific temperature to the stirring action of a paddle. When the slurry is heated starch granules swell and become a paste. Key measurements are taken at onset of gelatinization at which viscosity starts to develop, maximum viscosity, drop in viscosity during cooling. See FIG. 13 and Table 9 for an example of the viscosity changes in a starch subjected to the test method. The viscosity data is summarized in FIGS. 14-18.

Brabender® Micro Visco amylograph. Sample—10 g of starch-based composition was used with 105 g of distilled water. Program used:

### Start at 30° C.

### Heat at 7.5 C/min to 96° C.

(Start of holding period) Hold at 96° C. for 5 mins
(Start of cooling period) Cool at 7.5 C/min to 55° C. (End of cooling period)
Hold at 55° C. for 1 min (End of final holding period)
End of test

TABLE 9

| | Test 1 - dent starch | | | Test 2 - tapioca starch | | |
|---|---|---|---|---|---|---|
| | Time | Viscosity | Temp | Time | Viscosity | Temp |
| Evaluation point | [min] | [BU] | [° C.] | [min] | [BU] | [° C.] |
| Beginning of | 5.37 | 15 | 71.3 | 4.5 | 19 | 63.2 |
| gelatinization | | | | | | |
| Maximum | 7.97 | 629 | 90.1 | 5.87 | 985 | 76.2 |
| viscosity | | | | | | |
| Start of holding | 8.8 | 535 | 94.5 | 8.8 | 751 | 95.1 |
| period | | | | | | |
| Start of cooling | 13.8 | 354 | 96 | 13.8 | 707 | 95.9 |
| period | | | | | | |
| End of cooling | 19.27 | 762 | 56.4 | 19.27 | 1250 | 56.2 |
| period | | | | | | |
| End of final | 20.27 | 760 | 54.9 | 20.27 | 1276 | 55 |
| holding period | | | | | | |
| Breakdown | 0 | 275 | 0 | 0 | 278 | 0 |
| Setback | 0 | 408 | 0 | 0 | 543 | 0 |

The following are the starch-based compositions for which viscosity data is shown in FIGS. 14-18: Test 1—dent corn starch; Test 2—tapioca starch; Test 3—wheat starch; Test 4—7 g dent corn starch+3 g tapioca starch; Test 7—Test 4+0.1 g fumaric acid; Test 8—all the starches and gums in Formula 2 (Example 2)+0.1 g fumaric acid; Test 9—all the starches and gums in Formula 2 (Example 2); Test 13—7 g dent corn starch+3 g tapioca starch+0.1 g fumaric acid; Test 15—7 g dent corn starch+3 g tapioca starch+0.1 g fumaric acid+0.1 g citric acid.

### Example 6

This example provides texture profile data for bread made from compositions of the present invention.

Texture Profile Analysis (TPA) consists of a two stroke force being applied to the bread disc via a probe attached to the Texture Analyzer. The resulting force/time graphs were then calculated using XTRAD software, programmed with a TPA macro designed for calculating several textural properties. Measurements of Hardness, Springiness, Cohesiveness, Resilience, Gumminess, and Chewiness were determined.

### Texture Descriptions:

Hardness or firmness is defined as the force necessary to attain a given deformation, or the force required to compress a substance between molar teeth.

Springiness is defined as the ratio of duration of contact with the sample during the second compression to that of the sample for the first compression, or degree or rate at which the sample returns to its original size/shape after partial compression between tongue and palate.

These measurements are good indicators of staling, because as bread becomes stale, springiness decreases and hardness increases.

### Texture Profile Analysis Terms

Hardness. Human—force required to bite completely through the sample when placed between molars. Instrument—maximum load (g) applied to samples during first chew.

Cohesiveness Human—the degree to which a substance is compressed between the teeth before it breaks. Instrument—is defined as the extent to which a product can be deformed before it ruptures, or It is also the extent to which a product adheres to itself.

Resilience. Human—rate at which the sample returns to original shape after partial compression. “Bounce Factor” viscous dough, but at the same time more elastic.

Chewiness. Human—Total amount of work needed to chew a sample to a state ready for swallowing. Instrument—mathematical product of hardness, cohesiveness.

### Method

TPA Internal texture analysis—Using four ⅞″ slices from each loaf of bread, a 1″ circle is cut out of the center of each slice. The resulting disk is placed on the TAXT2 texture analyzer and a TPA test is performed.

TABLE 10

| | | | |
|---|---|---|---|
| Days of storage @ 72 F. | Hardness | Springiness | Chewiness |

Texture Profile Analysis (TPA) of Gluten - Free White Bread
(sliced, packaged, frozen and thawed)

| | | | |
|---|---|---|---|
| 1 | 9228 | 0.639 | 1936 |
| 4 | 9629 | 0.588 | 1650 |
| 7 | 10061 | 0.583 | 1739 |
| 10 | 9754 | 0.572 | 1577 |

Texture Profile Analysis (TPA) of Gluten Free White Bread
(sliced, packaged and held at 72° F.)

| | | | |
|---|---|---|---|
| Fresh | 9114 | 0.912 | 4089 |
| 5 days | 12530 | 0.688 | 2737 |

| | | | |
|---|---|---|---|
| Storage | Hardness | Springiness | Chewiness |

Texture Profile Analysis (TPA) of Gluten Free White Bread
(sliced, packaged and held at 72° F.)

| | | | |
|---|---|---|---|
| 0.1% Fumaric acid fresh | 7425 | 0.928 | 3826 |
| 0.1% Fumaric acid 5 days | 7881 | 0.876 | 2973 |

TABLE 11

| Sample | Hardness | Springiness | Chewiness |
|---|---|---|---|
| GF yellowcake fumaric acid | 611.163 | 0.958 | 475.518 |
| (fresh) | | | |
| GF yellow cake fumaric acid | 1076.77 | 0.938 | 793.861 |
| (after 5 days storage) | | | |
| GF yellow cake control | 5503.529 | 0.921 | 3675.368 |
| (fresh) | | | |
| GF yellow cake control | 7562.122 | 0.918 | 5029.297 |
| (after 5 days storage) | | | |

Surprisingly, addition of fumaric acid results in baked products with increased softness for both fresh and frozen products.

### Example 7

This example describes properties of bread and cake prepared from gluten-free compositions of the present invention.

TABLE 12

| Sample | Weight | Volume | Height | Width | Depth | Area | SpecVol |
|---|---|---|---|---|---|---|---|
| GF Bread T1 BSV #1 | 312.03 | 580 | 154 | 87 | 78 | 46 | 1.858686 |
| GF Bread T1 BSV #2 | 838.24 | 1700 | 210 | 125 | 102 | 96 | 2.028214 |
| GF Bread T2 BSV #1 | 307.83 | 871 | 145 | 101 | 108 | 75 | 2.830498 |
| GF Bread T2 BSV #2 | 826.59 | 2229 | 205 | 140 | 140 | 125 | 2.696604 |

“SpecVol” is fresh baked specific volume
T1 was prepared according to Example 2
T2 was prepared according to Example 2 with addition of 0.2% fumaric acid

Addition of fumaric acid results in baked products with increased baked specific volume.

### Example 8

An example of a cake formulation which did not exhibit desirable properties.

TABLE 13

| Ingredients | wt % |
|---|---|
| sugar | 23.6 |
| modified corn starch | 2.3 |
| corn starch | 15.4 |
| emulsified shortening | 8.6 |
| dextrose | 2.6 |
| egg whites | 1.7 |
| mono and diglycerides | 0.6 |
| Salt | 0.7 |
| xanthan | 0.3 |
| baking soda | 0.6 |
| SAPP 28 | 0.4 |
| SAPP 40 | 0.3 |
| MCP | 0.1 |
| whole eggs | 4.0 |
| egg whites | 10.0 |
| water | 30.0 |
| TOTAL | 100 |

This cake formulation with only corn starch exhibited acceptable volume. However, the cake exhibited peaking or cracking on top because the leavening was generating CO₂ even after the structure was set. The bread-like texture was not desirable as the grain was too open.

When only tapioca starch or potato starch were used in cake formulations, the structure of the cake resembled a starch paste and lacked typical cake grain with air cells embedded in the structure. Therefore, it was necessary to use a blend that did not set the structure too soon during baking. Various combinations were tested. When rice flour was used instead of tapioca and combined with corn starch, the resultant texture was gummy and dense. The cake had gritty mouthfeel.

### Example 9

An example of the water holding capacity (WHC) of bread formulations (Example 2, Table 8).

Water holding capacity of the flours was measured by using AACC method 56-10, which was modified as follows: distilled water was used instead of alkaline water. Therefore, the measurement is only water retention capacity and not alkaline water retention capacity.

TABLE 14

| | avg % WHC |
|---|---|
| wheat starch | 70.02099 |
| Formula 2 (starches only) | 72.69932 |
| Formula 3 (starches only) | 77.65506 |

What is claimed is:

1. A gluten-free composition for bread products comprising:
a) 15 to 50 weight percent gluten-free flour and/or starch, wherein the gluten-free flour or starch comprises corn starch;
b) 1 to 10 weight percent protein;
c) 0.1 to 10 weight percent hydrocolloid;
d) 25 to 50 weight percent water;
e) 0.5 to 5 weight percent yeast;
f) 0.5 to 5 weight percent emulsifier;
and optionally,
g) 0 to 12 weight percent fat
h) 0 to 5 percent by weight chemical leavening agent; and
i) 0 to 15 weight percent sweetener.
wherein the gluten-free flour and/or starch comprises starch granules, wherein at least 50% of the starch granules are 18 microns or less in size and at least 90% of the starch granules are 35 microns or less in size.

2. The composition of claim 1, further comprising acidulant selected from the group consisting of fumaric acid, acetic acid and combinations thereof, wherein the acidulant comprises 0.1 to 0.5 weight percent of the formulation.

3. The composition of claim 1, wherein the volume weighted mean of the starch granules is 45 microns or less.

4. The composition of claim 1, wherein the composition comprises:
a) 20 to 40 weight percent gluten-free flour and/or starch;
b) 2 to 7 weight percent protein;
c) 0.5 to 4 weight percent hydrocolloid;
d) 3 to 9 weight percent fat;
e) 30 to 45 weight percent water;
f) 1 to 3 weight percent yeast;
g) 0.2 to 2 weight percent chemical leavening agent;
g) 1 to 4 weight percent emulsifier; and
h) 2 to 10 weight percent sweetener or sweeteners.

5. The composition of claim 1, further comprising an additional flour and/or starch selected from the group consisting of tapioca flour, modified tapioca starch, potato starch, rice flour, and combinations thereof.

6. The composition of claim 1, wherein the protein is selected from the group consisting of powdered and/or liquid egg whites, egg yolk, whole eggs, and combinations thereof.

7. The composition of claim 1, wherein the hydrocolloid is selected from the group consisting of xanthan gum, guar gum, pectin, methyl cellulose, hydroxypropyl methylcellulose, and combinations thereof.

8. The composition of claim 1, wherein the fat is selected from the group consisting of shortening made from palm oil, palm kernel oil, coconut oil, canola oil, cottonseed oil, and combinations thereof.

9. A gluten-free composition for cake bakery products comprising:
a) 10 to 35 weight percent gluten-free flour or starch, wherein the gluten-free flour or starch comprises corn starch;
b) 1 to 10 weight percent protein;
c) 0.15 to 5 weight percent hydrocolloid;
d) 2 to 12 weight percent fat;
e) 15 to 50 weight percent water;
f) 0.5 to 4.5 weight percent chemical leavening agent;
g) 0.2 to 5 weight percent emulsifier;
and optionally,
h) 15 to 50 weight percent sweetener.
wherein the gluten-free flour or starch comprises starch particles, wherein at least 50% of the starch particles are 18 microns or less in size and at least 90% of the starch particles are 35 microns or less in size.

10. The composition of claim 9, further comprising acidulant selected from the group consisting of fumaric acid, acetic acid and combinations thereof, wherein the acidulant comprises 0.1 to 0.5 weight percent of the formulation.

11. The composition of claim 9, wherein the volume weighted mean of the starch granules is 45 microns or less.

12. The composition of claim 9, wherein the composition comprises:
a) 15 to 25 weight percent gluten-free flour and/or starch;
b) 2 to 6 weight percent protein;
c) 0.2 to 2 weight percent hydrocolloid;
d) 3 to 9 weight percent fat;
e) 20 to 45 weight percent water;
f) 1 to 3 weight percent chemical leavening agent;
g) 0.5 to 3.5 weight percent emulsifier; and
h) 25 to 45 weight percent sweetener or sweeteners.

13. The composition of claim 9, further comprising an additional flour and/or starch selected from the group consisting of tapioca flour, modified tapioca starch, potato starch, rice flour, and combinations thereof.

14. The composition of claim 9, wherein the protein is selected from the group consisting of powdered and/or liquid egg whites, egg yolk, whole eggs, and combinations thereof.

15. The composition of claim 9, wherein the hydrocolloid is selected from the group consisting of xanthan gum, guar gum, pectin, methyl cellulose, and combinations thereof.

16. The composition of claim 9, wherein the fat is selected from the group consisting of shortening made from palm oil, palm kernel oil, coconut oil, canola oil, cottonseed oil, and combinations thereof.

17. A bread product prepared from the composition of claim 1.

18. A cake product prepared from the composition of claim 9.
